(19) United States
(12) Patent Application Publication
(10) Pub. No.: US 2005/0052718 A1
(43) Pub. Date: Mar. 10, 2005

(54) Hologram projector for bird control

(76) Inventor: Denis Alan De Shon, Baton Rouge, LA (US)

Correspondence Address: DENIS ALAN DE SHON, 7242 SEVEN OAKS AVENUE, BATON ROUGE, LA, 70806, US

(21) Appl. No.: 10/656,787

(22) Filed: Sep. 5, 2003

(51) Int. Cl. G03H 1/00; G02B 5/32

(52) U.S. Cl. 359/15; 359/1

(57) ABSTRACT

A Hologram Projector is employed at Airports or Fisheries to keep bird species from either being a hazard to flight or predating the resource species of the Fishery. Images can be projected in the air which show either: a Hologram grid of wires over the property which wards off most birds, a Hologram of the undesired species in a Terror Position (wings askew, head moving jerkily) which will deter the birds, or a Hologram of a Raptor circling over the property which is a deterrent as well. The Holographic displays may be suspended during aircraft take-off or landing, if so desired.

### BACKGROUND OF THE INVENTION

1. Field of the Invention

The present invention relates generally to the control of birds on airports, hatcheries and other areas by the projection of a Hologram, where birds present either a hazard to aircraft or act as predators on resource species.

2. Description of the Prior Art

Birds which present either hazards or predation have been controlled through shooting, noise generators, lasers, scarecrows and other means. These have had minimal success in dealing with the bird problem. None have addressed the employment of a Hologram Generator to portray either a grid over the property (which birds abhor) a bird in a terror situation or a bird predator such as a Hawk.

### SUMMARY OF THE INVENTION

The invention is a Hologram Projector used to control birds. It is situated at a site where birds present a hazard to aircraft (generally sea gulls, but other species as well,) or act as predators (generally Cormorants and the like) on resource species (fisheries, hatcheries and the like.)

The Hologram Projector can generate any type of visual items which are desired by the operator which serve to keep birds off of the location.

A Hologram grid can be projected over runways, which visually appears to be either electric lines or metal cables. Birds will generally avoid such hazards.

Or a Hologram bird can be projected onto the grid in the Terror position (Wings awry, head moving jerkily) which shows the real birds a Danger situation and causes them not to land or loaf on the runways.

Alternatively a Hawk can be projected in flight above the runway or hatchery which sends a signal to the birds not to enter the area.

This Hologram grid can be turned off as aircraft take off or land on the runways if it distracts the pilots or interferes with airborne electronics.

Additionally, sound effects may be used to enhance the hologram effects.

### BRIEF DESCRIPTION OF THE DRAWINGS

Referring to the Drawings, which are for illustrative purposes only:

FIG. 1 is a schematic view of an airport runway which shows a grid projected over the runway.

FIG. 2 is a schematic view of a hatchery with a hawk projected over it.

### DESCRIPTION OF THE PRESENT EMBODIMENT

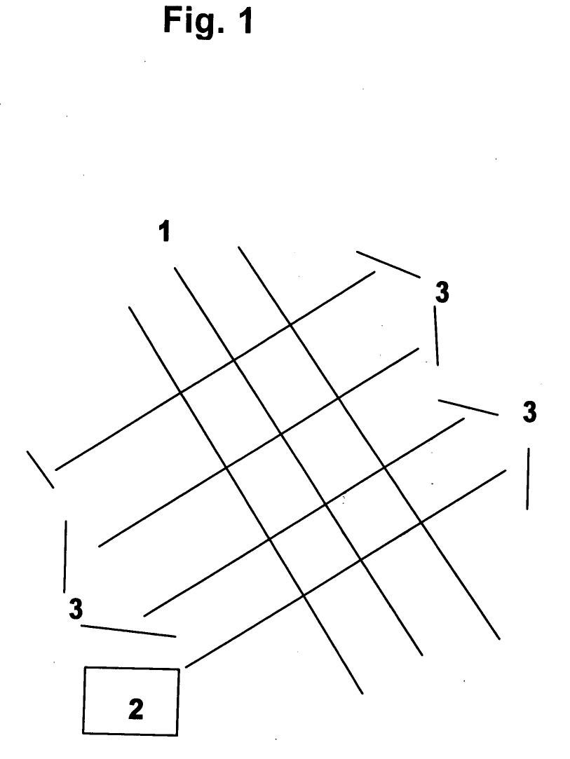

FIG. 1 is a schematic view of an airport runway (1) on which a Hologram Projector (2) is employed to produce a grid over the runway, providing negative visual stimulus to the Gulls, or other species, intent upon loafing or landing on the runway. This visual image will serve to keep the birds at bay.

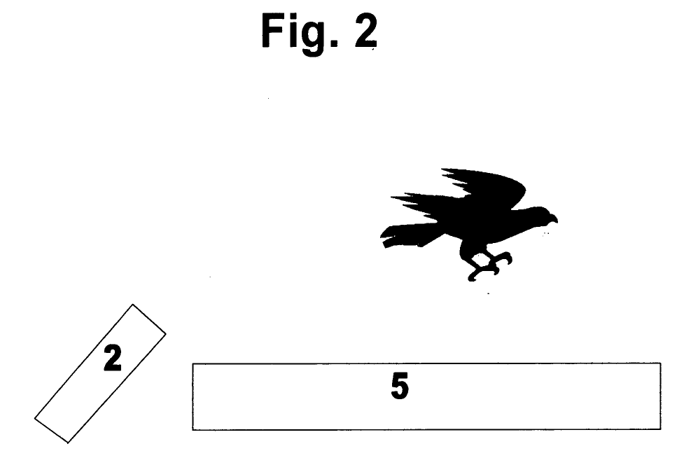

FIG. 2 is a schematic view of a Hatchery(3) employing a Hologram Projector(2) to produce a visual image of a large Hawk circling over the property in an effort to keep predating avian species away from the resource (fingerlings, fish, crawfish and the like.)

1. A Hologram Projector disposed at airport runways or fisheries ponds to control bird activity, which holograms are shaped as a grid, a target species, or a raptor and are projected in the air above the resource, in order to keep birds away from the airport site and eliminate predation on ponds.
